(19) United States
(12) Patent Application Publication
(10) Pub. No.: US 2012/0200553 A1
(43) Pub. Date: Aug. 9, 2012

(54) MULTIPLE POLARITY INVERSION DRIVING METHOD AND DISPLAY DRIVER, TIMING CONTROLLER, AND DISPLAY DEVICE USING THE SAME

(75) Inventors: Tse-Hung WU, New Taipei City (TW); Sou-Chieh Chang, Hsinchu City (TW)

(73) Assignee: NOVATECK MICROELECTRONICS CORP., Hsinchu (TW)

(21) Appl. No.: 13/283,056

(22) Filed: Oct. 27, 2011

(30) Foreign Application Priority Data
Feb. 9, 2011 (TW) 100104339

(51) Int. Cl. G09G 5/00; G09G 3/36

(52) U.S. Cl. 345/211; 345/99

(57) ABSTRACT

A multiple polarity inversion driving method is provided, capable of being operated in a number of inversion schemes, and being flexibly adjusted in accordance with different design requirements and application conditions. The driving method includes providing display data in accordance with an inversion switching time unit as a repeated time unit. The inversion switching time unit has a number of different types of polarity distribution pattern intervals. Additionally, the display data provided to the different types of polarity distribution pattern intervals respectively have different types of polarity distribution patterns on the display.

This application claims the benefit of Taiwan application Serial No. 100104339, filed Feb. 9, 2011, the subject matter of which is incorporated herein by reference.

### BACKGROUND OF THE INVENTION

1. Field of the Invention

The invention relates in general to a polarity inversion driving method, and more particularly to a polarity inversion driving method capable of being operated in a number of different inversion schemes.

2. Description of the Related Art

With rapid advance in technology, liquid crystal display has been provided and widely used in various applications. In general, the liquid crystal cells of the liquid crystal display cannot be fixed at a particular voltage, otherwise the liquid crystal cells, once the characteristics are damaged, can no longer be rotated in response to the change in electrical field to form different grey levels. Thus, the voltage must be resumed every period of time to avoid damaging the characteristics of the liquid crystal cells.

Therefore, different polarity inversion driving methods are provided. According to the frame polarity inversion driving method, the polarities of the display data provided to the liquid crystal cells are inverted every one frame. According to the column polarity inversion driving method, the polarities of the display data provided to the liquid crystal cells are inverted every predetermined number of pixel columns. Likewise, according to the row polarity inversion driving method, the polarities of the display data provided to the liquid crystal cells are inverted every predetermined number of pixel rows. According to the dot polarity inversion driving method, the polarities of the display data provided to the liquid crystal cells are inverted every predetermined number of pixels.

Each polarity inversion driving method has its advantages and disadvantages. For example, the column polarity inversion driving method is superior in eliminating the data delay of the data line and reducing power consumption but may trigger vertical flickering and vertical crosstalk and thus deteriorate the image quality. The frame polarity inversion driving method is superior in saving power consumption but the resultant image quality is the worst among these methods. The dot polarity inversion driving method is superior in eliminating crosstalk but is worst in saving power consumption.

Of the aforementioned generally known polarity inversion driving methods, none is superior in all aspects such as display effect (e.g. crosstalk elimination) and power consumption. In addition, the aforementioned polarity inversion driving methods cannot be adjusted in accordance with different design requirements and application conditions (such as device characteristics).

Therefore, how to provide a polarity inversion driving method capable of being flexibly adjusted in accordance with different design requirements and application conditions and achieving optimum performance in various aspects, such as display effect and power consumption, has become an imminent task for the industries.

### SUMMARY OF THE INVENTION

The invention is directed to a multiple polarity inversion driving method. In comparison to conventional polarity inversion driving method, the multiple polarity inversion driving method of the invention is capable of being operated in a number of different inversion schemes and being flexibly adjusted in accordance with different design requirements and application conditions, hence achieving excellent or ideal performance in terms of display effect (such as elimination of crosstalk), power consumption and other aspects.

According to a first aspect of the present invention, a multiple polarity inversion driving method which can be used for driving a display is provided. The driving method includes providing display data in accordance with an inversion switching time unit as a repeated time unit. The inversion switching time unit has different types of polarity distribution pattern intervals. Additionally, the display data provided to the different types of polarity distribution pattern intervals respectively have different types of polarity distribution patterns on the display.

According to a second aspect of the present invention, a display driver including a timing controller and a data driver is provided. The timing controller instructs the inversion switching time unit having different types of polarity distribution pattern intervals. Display data are provided to a display in accordance with an inversion switching time unit as a repeated time unit. Additionally, the display data provided to different types of polarity distribution pattern intervals by the data driver respectively have different types of polarity distribution patterns on the display.

According to a third aspect of the present invention, a display device is provided. The display device includes a display driver and a display. The display is used for displaying corresponding image frames according to the display data provided by the display driver.

According to a fourth aspect of the present invention, a display device is provided. The display device includes: a display driver and a display. The display driver is used for providing display data in accordance with an inversion switching time unit as a repeated time unit, wherein the inversion switching time unit has a number of different types of polarity distribution pattern intervals. The display is used for displaying corresponding image frames according to the display data provided by the display driver, wherein the display data provided to the different types of polarity distribution pattern intervals respectively have different types of polarity distribution patterns on the display.

According to a fifth aspect of the present invention, a timing controller is provided. The timing controller includes: a timing controller used for instructing an inversion switching time unit. The inversion switching time unit has a number of different types of polarity distribution pattern intervals for driving a data driver, so that the data driver provides display data to a display in accordance with an inversion switching time unit as a repeated time unit. Additionally, the display data provided to different types of polarity distribution pattern intervals by the data driver respectively have different types of polarity distribution patterns on the display.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a display driver according to an embodiment;

FIG. 2 shows an inversion switching time unit according to an embodiment;

FIG. 3 shows a schematic diagram of the polarity inversion of the display data displayed on the display in accordance with an example of FIG. 2;

FIG. 4 shows another schematic diagram of the polarity inversion the display data displayed on the display in accordance with another example of FIG. 2;

FIG. 5 shows an inversion switching time unit according to another embodiment;

FIG. 6 shows a schematic diagram of the polarity inversion the display data displayed on the display in accordance with an example of FIG. 5;

FIG. 7 shows a flowchart of a multiple polarity inversion driving method according to an embodiment;

FIG. 8 shows a partial flowchart of a multiple polarity inversion driving method according to another embodiment;

FIGS. 9-11 are related signal timing diagrams of a display driver according to an embodiment.

### DETAILED DESCRIPTION OF THE INVENTION

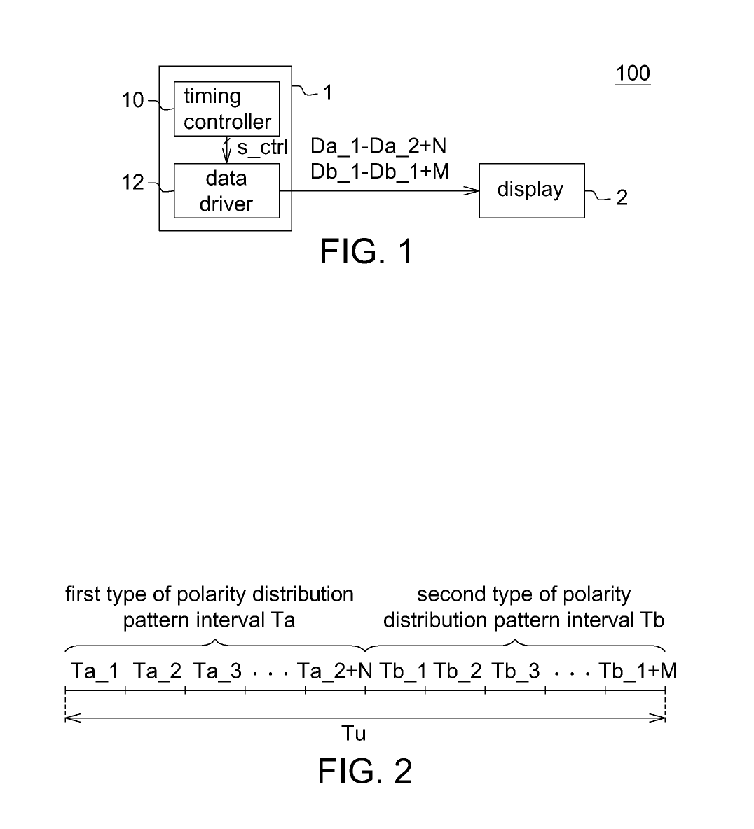

Referring to FIG. 1, a block diagram of a display driver according to an embodiment is shown. The display driver 1, used in a display device 100, provides display data for driving a display 2 to display corresponding image frames. The display driver 1 includes a timing controller 10 and a data driver 12. The timing controller 10 is used for generating a timing control signal S_ctrl. The timing control signal S_ctrl normally includes different types of signals, such as control signals, pulse signals, data signals and polarity control signals, for controlling the data driver 12 to receive display data and provide the received display data to corresponding data lines on the display 2 and timely adjust the polarities of the display data.

The present embodiment has a unique feature in that the display driver 1 is capable of being operated in a number of different inversion schemes. In other words, the display driver 1 adopts a multiple polarity inversion driving method rather than a single polarity inversion driving method as adopted in generally known technology.

To achieve the above feature, the timing control signal S_ctrl preferably instructs an inversion switching time unit Tu and controls the data driver 12 to provide display data to display 2 in accordance with an inversion switching time unit Tu as a repeated time unit. The number of times of using the inversion switching time unit Tu does not need to be specified or can be specified as a predetermined number of times (such as one or more times). The inversion switching time unit has different types of polarity distribution pattern intervals. In other words, the inversion switching time unit has at least two different types of polarity distribution pattern intervals. Of the different types of polarity distribution pattern intervals, the display data provided by the data driver 12 respectively have different types of polarity distribution patterns on the display 2. Preferably, at least one of the different types of polarity distribution patterns is selected from the following types of polarity distribution patterns, namely, row inversion, column inversion, single dot inversion, multi-dot inversion, multi+multi-dot inversion, and frame inversion.

It is noted that the ratio among the durations of different types of polarity distribution pattern intervals preferably meets a specific requirement. That is, in each polarity inversion switching time, the total number of times of switching each pixel of the display 2 from positive polarity to negative polarity is substantially equal to the total number of times of switching each pixel of the display from negative polarity to positive polarity.

Referring to FIG. 2, an inversion switching time unit Tu according to an embodiment is shown. In the present embodiment, the inversion switching time unit Tu includes a first type of polarity distribution pattern interval Ta and a second type of polarity distribution pattern interval Tb. Besides, the ratio between the durations of the first type and the second type of polarity distribution pattern intervals Ta and Tb meets the aforementioned requirement regarding polarity inversion.

In a preferred embodiment (illustrated in FIG. 2), to meet the aforementioned requirement regarding the number of times of switching, the ratio between the durations of the first type and the second type of polarity distribution pattern intervals Ta and Tb can be arranged as 2+N:1+M, wherein M and N are both integers. To put it in greater details, the first type of polarity distribution pattern interval Ta includes 2+N frame cycles Ta_1, Ta_2, . . . , Ta_2+N, and the second type of polarity distribution pattern interval Tb includes 1+M frame cycles Tb_1, Tb_2, . . . , Tb_1 +M. Preferably, to meet the aforementioned requirement, N and M can be arranged to satisfy that condition that N+M equals 0 or a positive even number.

Under such disposition, during the period of 2+N frame cycles Ta_1˜Ta_2+N in the first type of polarity distribution pattern interval Ta, the 2+N first display data Da_1, Da_2, . . . , Da_2+N provided by the data driver 12 have the first type of polarity distribution pattern on the display 2. Besides, during the period of the 1+M frame cycles Tb_1˜Tb_1+M in the second type of polarity distribution pattern interval Tb, the second frame data Db_1, Db_2, . . . , Db_1+M provided by the data driver 12 have the second type of polarity distribution pattern on the display 2. The second type of polarity distribution pattern is not the same with the first type of polarity distribution pattern.

For example, one of the first type and the second type of polarity distribution patterns is such as in accordance with one of row inversion and dot inversion, and the other of the first type and the second type of polarity distribution patterns is such as in accordance with one of column inversion and frame inversion.

In another example, one of the first type and the second type of polarity distribution patterns is, such as, in accordance with one of column inversion and frame inversion, and the other of the first type and the second type of polarity distribution patterns is, such as, in accordance with one of row inversion and dot inversion.

In further another example, one of the first type and the second type of polarity distribution patterns is, such as, n-dot inversion, and the other of the first type and the second type of polarity distribution patterns is, such as, in accordance with one of row inversion, dot inversion, column inversion, frame inversion, n′-dot inversion and m+n″-dot inversion, wherein n, n′, m and n″ are natural numbers larger than 1.

In yet another example, one of the first type and the second type of polarity distribution patterns is, such as, m+n-dot inversion, and the other of the first type and the second type of polarity distribution patterns is, such as, in accordance with one of row inversion, dot inversion, column inversion, frame inversion, n′-dot inversion and m′+n″ dot inversion, wherein m, n, n′, m′ and n″ are natural numbers larger than 1.

In the embodiment illustrated in FIG. 2, it is exemplified that the ratio between the durations of the first type and the second type of polarity distribution pattern intervals Ta and Tb in the inversion switching time unit Tu equals 2+N:1+M, but the invention is not limited thereto. In other examples, the ratio between the durations of the first type and the second type of polarity distribution pattern intervals Ta and Tb can be simplified as N″:M″. That is, the first type and the second type of polarity distribution pattern intervals Ta and Tb respectively include N″ frame cycles and M″ frame cycles, wherein N″, M″ are integers.

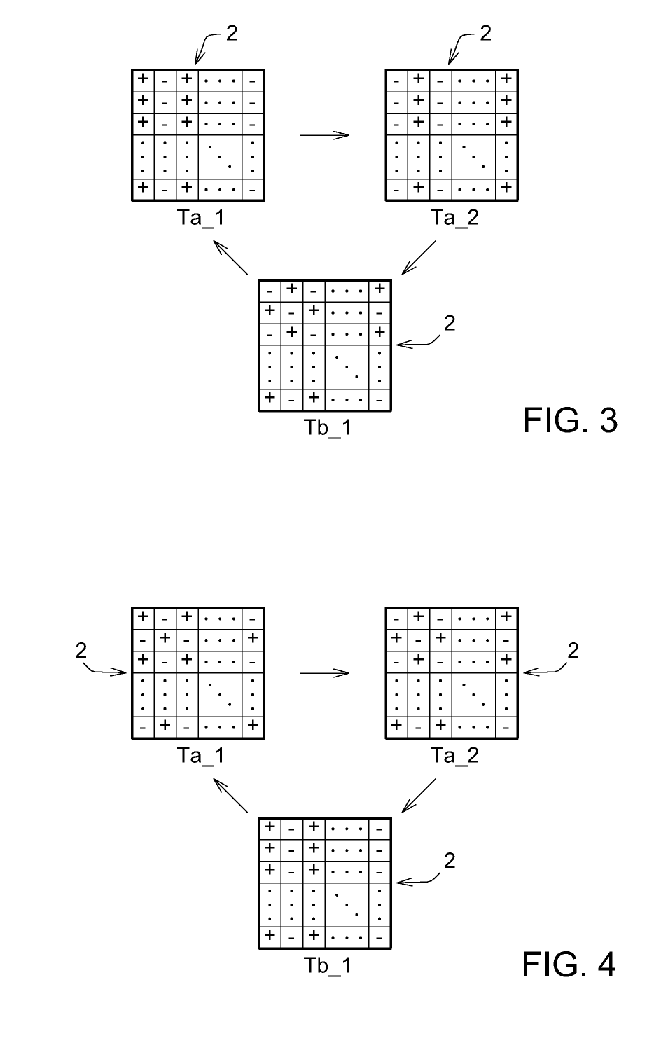

Referring to FIG. 3, a schematic diagram of the polarity inversion of the display data displayed on the display 2 in accordance with an example of the inversion switching time unit Tu of FIG. 2 is shown. In the present example, it is exemplified that N=0 and M=0. To put it in greater details, in the inversion switching time unit Tu, the first type of polarity distribution pattern interval Ta includes two frame cycles Ta_1 and Ta_2, and the second type of polarity distribution pattern interval Tb includes one second type of polarity distribution pattern interval Tb_1. During the frame periods Ta_1 and Ta_2 of the first type of polarity distribution pattern interval Ta, the first display data Da_1 and Da_2 correspond to the polarity distribution pattern in accordance with column inversion, and during the frame period Tb_1 of the second type of polarity distribution pattern interval Tb, the second display data Db_1 correspond to the polarity distribution pattern in accordance with dot inversion. Additionally, the inversion switching time unit Tu of the present embodiment meets the aforementioned requirement regarding the number of times of switching.

Referring to FIG. 4, a schematic diagram of the polarity inversion of the display data displayed on the display 2 in accordance with another example of the inversion switching time unit Tu of FIG. 2 is shown. FIG. 4 is different from FIG. 3 mainly in that the first display data Da_1 and Da_2 displayed in the first type of polarity distribution pattern interval Ta of FIG. 4 correspond to the polarity distribution pattern in accordance with dot inversion, and the second display data Db_1 displayed in the second type of polarity distribution pattern interval Tb correspond to the polarity distribution pattern in accordance with column inversion. Additionally, the inversion switching time unit Tu of the present embodiment meets the aforementioned requirement regarding the number of times of switching.

In the aforementioned embodiments disclosed in FIGS. 2˜4, it is exemplified that the inversion switching time unit Tu determined by the timing controller 10 includes two types of polarity distribution pattern interval Ta and Tb, but the invention is not limited thereto. That is, the inversion switching time unit Tu may include more than two types of polarity distribution pattern intervals.

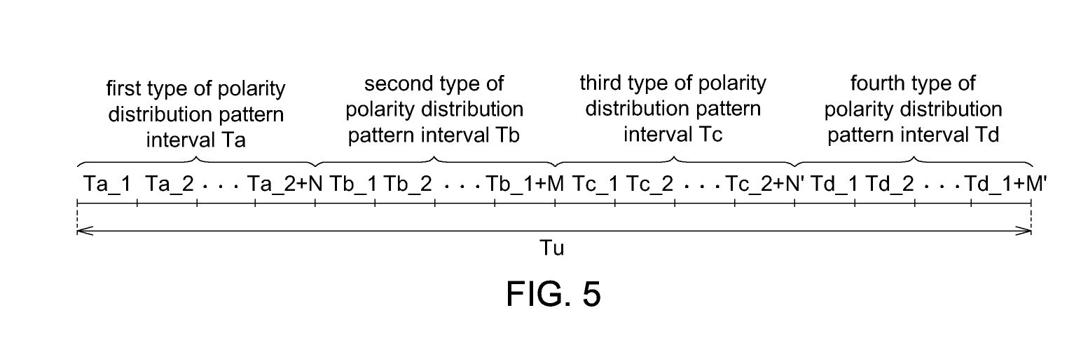

Referring to FIG. 5, an inversion switching time unit Tu according to another embodiment is shown. In the present embodiment, the inversion switching time unit Tu further includes a third type of polarity distribution pattern interval Tc and a fourth type of polarity distribution pattern interval Td in addition to the first type and the second type of polarity distribution pattern intervals Ta and Tb.

Like FIG. 2, in each polarity inversion switching time Tu, the total number of times of switching each pixel of the display 2 from positive polarity to negative polarity is substantially equal to the total number of times of switching each pixel of the display from negative polarity to positive polarity. For example, it can be arranged that the ratio between the durations of the first type and the second type of polarity distribution pattern intervals Ta and Tb meets the aforementioned requirement regarding polarity inversion, and that the ratio between the durations of the third and the fourth type of polarity distribution pattern intervals Tc and Td meets the aforementioned requirement regarding polarity inversion.

In a preferred embodiment, to meet the aforementioned requirement regarding the number of times of switching, it can be arranged that the ratio between the durations of the third and the fourth type of polarity distribution pattern intervals Tc and Td equals 2+N′:1+M′, wherein N′ and M′ are integers larger than or equal to 0. To put it in greater details, the third type of polarity distribution pattern interval Tc includes 2+N′ frame cycles Tc_1, Tc_2, . . . , Tc_2+N′, and the fourth type of polarity distribution pattern interval Td includes 1+M′ frame cycles Td_1, Td_2, . . . , Td_1 +M′.

Under such disposition, during the period of the 2+N′ frame cycles Tc_1˜Tc_2+N′ of the third type of polarity distribution pattern interval Tc, the 2+N′ third display data Dc_1, Dc_2, . . . , Dc_2+N′ provided by the data driver 12 have the third polarity distribution pattern on the display 2. Besides, during the period of the 1+M′ frame cycles Td_1˜Td_1+M′ of the fourth type of polarity distribution pattern interval Td, the 1+M′ fourth display data Dd_1, Dd_2, . . . , Dd_1+M′ provided by the data driver 12 have the fourth polarity distribution pattern on the display 2, wherein the fourth polarity distribution pattern is different from the third polarity distribution pattern.

Like the first and the second polarity distribution patterns, one of the third and fourth polarity distribution patterns is such as in accordance with one of row inversion and dot inversion, and the other of the third and fourth polarity distribution patterns is such as in accordance with one of column inversion and frame inversion.

In another example, one of the third and the fourth polarity distribution patterns is such as in accordance with one of column inversion and frame inversion, and the third and the fourth polarity distribution patterns the other of is such as in accordance with one of row inversion and dot inversion.

In further another example, one of the third and the fourth polarity distribution patterns is such as in accordance with n-dot inversion, and the other of the third and the fourth polarity distribution patterns is such as in accordance with one of row inversion, dot inversion, column inversion, frame inversion, n′-dot inversion and m+n″-dot inversion, wherein n, n′, m and n″ are natural numbers larger than 1.

In yet another example, one of the third and the fourth polarity distribution patterns is such as in accordance with m+n-dot inversion, and the other of the third and the fourth polarity distribution patterns is such as in accordance with one of row inversion, dot inversion, column inversion, frame inversion, n′-dot inversion and m′+n″ dot inversion, wherein m, n, n′, m′ and n″ are natural numbers larger than 1.

In the embodiment illustrated in FIG. 5, it is exemplified that the ratio among the durations of the first type to the fourth type of polarity distribution pattern intervals Ta˜Td in the inversion switching time unit Tu equals 2+N:1+M:2+N′:1+M′, but the invention is not limited thereto. In other examples, the ratio among the durations of the first type to the fourth type of polarity distribution pattern intervals Ta˜Td can be simplified as N″:M″:N′″:M′″. That is, the first type to the fourth type of polarity distribution pattern intervals Ta˜Tb respectively include N″, M″, N′″ and M′″ frame cycles, wherein N″, M″, N′″ and M′″ are integers.

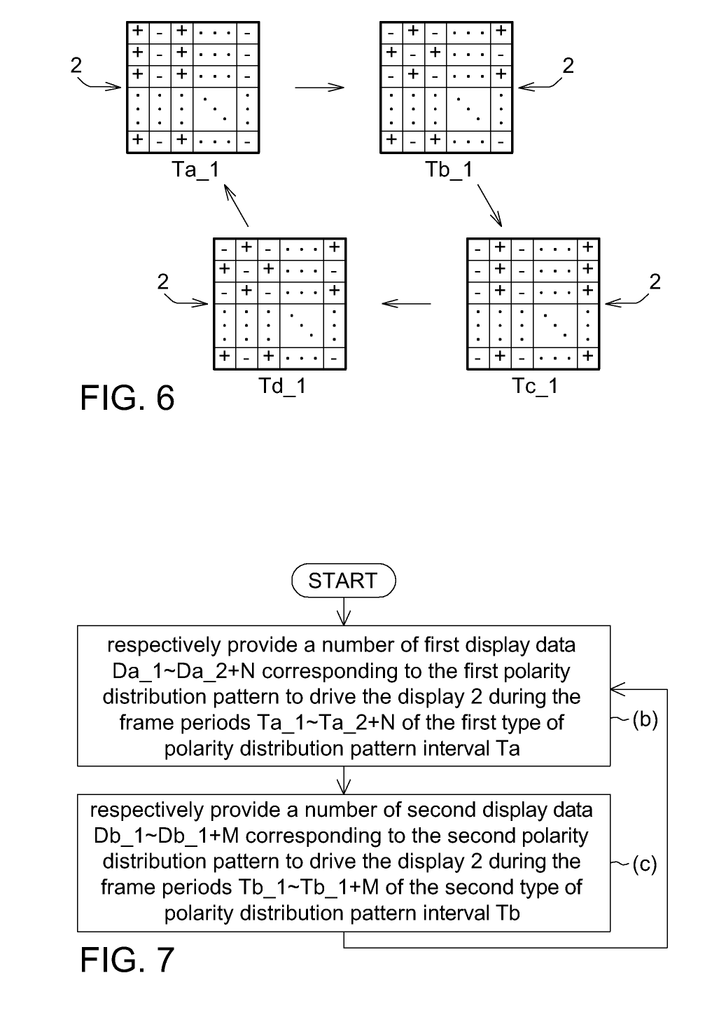

Referring to FIG. 6, a schematic diagram of the polarity inversion of the display data displayed on the display 2 in accordance with an example of the inversion switching time unit Tu of FIG. 5 is shown. In the present example, it is exemplified that N, N′, M and M′ equal −1, −1, 0 and 0 respectively. To put it in greater details, in the inversion switching time unit Tu, the first type of polarity distribution pattern interval Ta includes a frame cycle Ta_1, the second type of polarity distribution pattern interval Tb includes a frame cycle Tb_1, the third type of polarity distribution pattern interval Tc includes a frame cycle Tc_1, and the fourth type of polarity distribution pattern interval Td also includes a frame cycle Td_1. During the frame periods Ta_1 and Tc of the first type and the third type of polarity distribution pattern intervals, the first and the third display data Da_1 and Dc_1 correspond to the polarity distribution pattern in accordance with column inversion, and during the frame periods Tb_1 and Td_1 of the second and the fourth type of polarity distribution pattern interval, the second and the fourth display data Db_1 and Dd_1 correspond to the polarity distribution pattern in accordance with dot inversions. Additionally, the inversion switching time unit Tu of the present embodiment meets the aforementioned requirement regarding the number of times of switching.

In another application example, to meet the aforementioned requirement regarding the number of times of switching, wherein N and M N and M are integers satisfying one of the condition that N+M is equal to 0 and the other condition that N+M is equal to any positive even number, and N′ and M′ are integers satisfying one of the condition that N′ and M′ is equal to 0 and the other condition that N′+M′ is equal to any positive even number. According to the above disclosure, the inversion switching time unit Tu′ equivalently includes two segments of inversion switching time unit Tu illustrated in FIG. 2, and the detailed patterns of polarity distribution can be obtained from the disclosure of FIGS. 2 to 4, and the similarities are not repeated here.

Referring to FIG. 7, a flowchart of a multiple polarity inversion driving method according to an embodiment is shown. In the present embodiment, display data are provided in accordance with an inversion switching time unit Tu as a repeated time unit. The inversion switching time unit Tu includes a first type of polarity distribution pattern interval Ta and a second type of polarity distribution pattern interval Tb. The multiple polarity inversion driving method of the present embodiment includes the following steps:

Step (b): during the frame periods Ta_1 ˜Ta_2+N of the first type of polarity distribution pattern interval Ta, a number of first display data Da_1˜Da_2+N corresponding to the first polarity distribution pattern are respectively provided to drive the display 2.

Step (c): during the frame periods Tb_1˜Tb_1+M of the second type of polarity distribution pattern interval Tb, a number of second display data Db_1˜Db_1+M corresponding to the second polarity distribution pattern are respectively provided to drive the display 2.

It is noted that since the inversion switching time unit Tu is used as a repeated time unit, after steps (b) and (c) are sequentially performed, the process returns to step (b). In short, the number of times of using the inversion switching time unit Tu does not need to be specified or can be specified as a predetermined number of times (such as one or more times). Besides, any of the steps (b) and (c) can be used as the starting step or the ending step, and the process does not have to start with step (b) or terminate with step (c). Detailed operations of steps (b) and (c) can be obtained from FIGS. 2˜4, and the similarities are not repeated here.

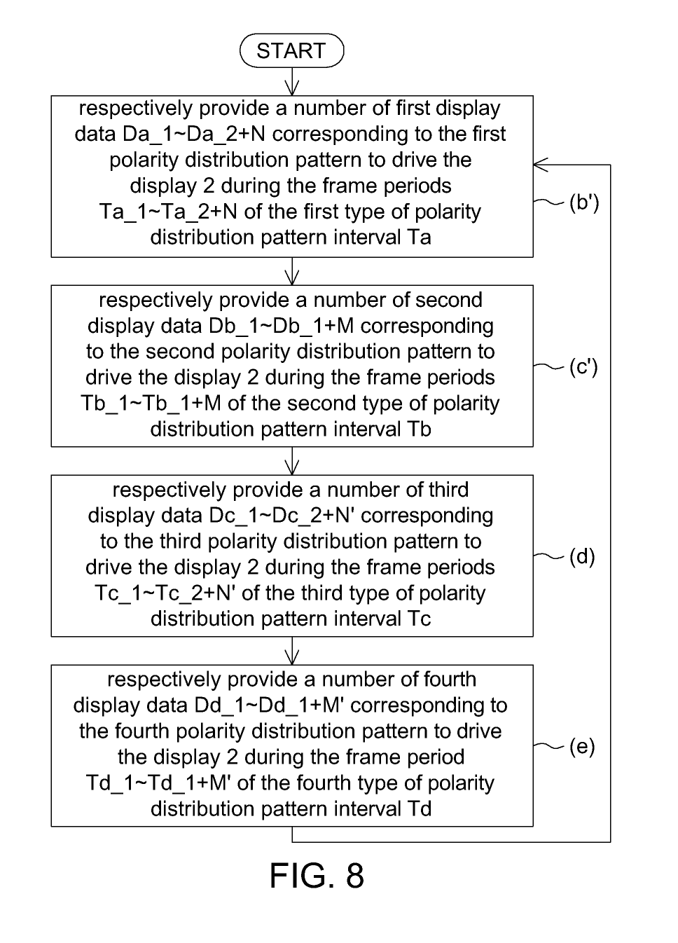

Referring to FIG. 8, a partial flowchart of a multiple polarity inversion driving method according to another embodiment is shown. FIG. 8 is different from FIG. 7 mainly in that the inversion switching time unit Tu determined in step (a) of FIG. 8 further includes a third type of polarity distribution pattern interval Tc and a fourth type of polarity distribution pattern interval Td. In the present embodiment, the multiple polarity inversion driving method further includes following steps (d) and (e) in the wake of steps (b′)˜(c′) which are similar to steps (b)˜(c) of FIG. 7.

Step (d): during the frame periods Tc_1˜Tc_2+N′ of the third type of polarity distribution pattern interval Tc, a number of third display data Dc_1˜Dc_2+N′ corresponding to the third polarity distribution pattern are respectively provided to drive the display 2.

Step (e): during the frame period Td_1˜Td_1+M′ of the fourth type of polarity distribution pattern interval Td, a number of fourth display data Dd _1˜Dd_1+M′ corresponding to the fourth polarity distribution pattern are respectively provided to drive the display 2.

It is noted that since the inversion switching time unit Tu is used as a repeated time unit, after steps (b′)˜(e) are sequentially performed, the process returns to step (b′). In short, the number of times of using the inversion switching time unit Tu does not need to be specified or can be specified as a predetermined number of times (such as one or more times). Besides, any of the steps (b′)˜(e) can be used as the starting step or the ending step, and the process does not have to start with step (b′) or terminate with step (e′). Detailed operations of steps (b′)˜(c′) and steps (c)˜(d) can be obtained from FIGS. 2˜4 and FIGS. 5˜6, and the similarities are not repeated here.

The aforementioned multiple polarity inversion driving method can be implemented in many different ways. For example, the control wave-patterns of a polarity control signal POL of the timing control signals S_ctrl can be used to achieve the desired inversion switching time unit. In general, when the polarity control signal POL is at the first level (such as high signal level), the polarity of the pixel data outputted to the corresponding pixel is negative. To the contrary, when the polarity control signal POL is at the second level (such as low signal level), the polarity of the pixel data outputted to the corresponding pixel is positive.

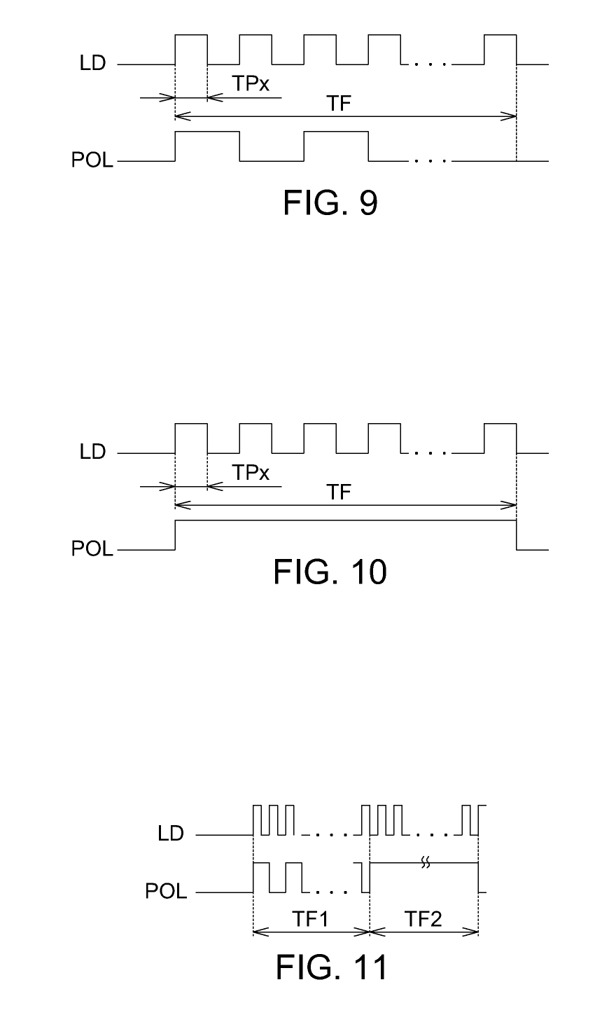

For example, during the period of each inversion switching time unit, when the polarity distribution pattern of the display 2 is in accordance with dot inversion or column inversion, the timing relationship between the polarity control signal POL and the pixel data loading signal LD is as illustrated in FIG. 9. In greater details, the polarity control signal POL is at the first signal level (such as high signal level) during a part of a pixel data loading period TPx (such as the loading period for odd-numbered pixel data) of a pixel data scanning period TF, so that the polarity of the pixel data of the pixels corresponding to these pixel data loading periods is negative. The polarity control signal POL is converted to be at the second signal level (such as low signal level) during the other part of the pixel data loading period Tpx (such as the loading period for even-numbered pixel data) of the pixel data scanning period TF, so that the polarity of the pixel data of the pixels corresponding to these pixel data loading periods is positive.

In another example, during the period of each inversion switching time unit, when the polarity distribution pattern of the display 2 is in accordance with frame inversion, the timing relationship between the polarity control signal POL and the pixel data loading signal LD is as illustrated in FIG. 10. In greater details, the polarity control signal POL corresponds to high signal level during all pixel data loading period TPx of a pixel data scanning period TF, so that the polarity of the pixel data of the pixel rows corresponding to the pixel data scanning period is negative.

The above two situations are combined below. In order to drive the display, the display driver 1 of the present embodiment has to provide pixel data corresponding to different polarity distribution patterns in the first type and the second type of polarity distribution pattern intervals Ta and Tb respectively, and the timing relationship between the polarity control signal POL and the pixel data loading signal LD is as illustrated in FIG. 11.

It is noted that the ratio among the durations of different types of polarity distribution pattern intervals is determined in accordance with the aforementioned number of times of switching as well as design requirements, application conditions and device characteristics. In addition, the types and the number of polarity distribution pattern intervals included in the inversion switching time unit used as a repeated time unit is also determined in according with design requirements, application conditions and device characteristics. For example, the ratio of the durations among different types of polarity distribution pattern intervals can be adjusted based on a single one or more of different factors such as the crosstalk of the display, the target power consumption and so on.

It is noted that in the above embodiments one single polarity distribution pattern interval is used for exemplification. However, in other embodiments, multiple polarity distribution pattern intervals can also be used. In other words, after display data are provided in accordance with the inversion switching time unit as a time unit, subsequent display data are provided in accordance with another one or more inversion switching time units as repeated time unit respectively, and each polarity distribution pattern interval can use a predetermined number of times (such as one or more times).

In comparison to the generally known technology which uses one single type of polarity inversion driving method and is unable to concurrently meet the requirements of display effect and power consumption, the above embodiments adopt different types of polarity inversion driving methods and are capable of flexibly adjusting the ratio of the durations among different types of polarity distribution pattern intervals in accordance with design requirements and application conditions, hence achieving excellent or ideal performance in terms of display effect, power consumption and other aspects.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multiple polarity inversion driving method for driving a display, wherein the method comprises:
providing display data in accordance with an inversion switching time unit as a repeated time unit,
wherein the inversion switching time unit has a number of different types of polarity distribution pattern intervals,
wherein the display data provided to the different types of polarity distribution pattern intervals respectively have different types of polarity distribution patterns on the display.

2. The multiple polarity inversion driving method according to claim 1, wherein in the polarity inversion switching time, the total number of times that each pixel of the display is switched from positive polarity to negative polarity is substantially equal to the total number of times that each pixel of the display is switched from negative polarity to positive polarity.

3. The multiple polarity inversion driving method according to claim 1, wherein at least one of the different types of polarity distribution patterns is selected from one of row inversion, column inversion, single dot inversion, multi-dot inversion, multi+multi-dot inversion, and frame inversion.

4. The multiple polarity inversion driving method according to claim 1, wherein in the inversion switching time unit, the different types of polarity distribution pattern intervals comprise:
a first type of polarity distribution pattern interval, wherein the provided display data have the first type of polarity distribution pattern on the display; and
a second type of polarity distribution pattern interval, wherein the provided display data have the second type of polarity distribution pattern on the display.

5. The multiple polarity inversion driving method according to claim 4, wherein one of the first type and the second type of polarity distribution pattern intervals comprises 2+N frame cycles, and the other comprises 1+M frame cycles with N and M being integers satisfying one of a condition that N+M is equal to 0 and an other condition that N+M is equal to any positive even number.

6. The multiple polarity inversion driving method according to claim 4, wherein one of the first type and the second type of polarity distribution pattern is in accordance with one of row inversion and dot inversion, and the other is in accordance with one of column inversion and frame inversion.

7. The multiple polarity inversion driving method according to claim 4, wherein one of the first type and the second type of polarity distribution patterns is n-dot inversion, the other of the first type and the second type of polarity distribution pattern is in accordance with one of row inversion, dot inversion, column inversion, frame inversion, n′-dot inversion and m+n″-dot inversion, with n, n′, m and n″ being natural numbers larger than 1.

8. The multiple polarity inversion driving method according to claim 4, wherein one of the first type and the second type of polarity distribution pattern is m+n-dot inversion, the other of the first type and the second type of polarity distribution pattern is in accordance with one of row inversion, dot inversion, column inversion, frame inversion, n′-dot inversion and m′+n″ dot inversion with m, n, n′, m′ and n″ being natural numbers larger than 1.

9. The multiple polarity inversion driving method according to claim 4, wherein in the inversion switching time unit, different types of polarity distribution pattern intervals further comprise:
a third type of polarity distribution pattern interval, wherein the provided display data have the third type of polarity distribution pattern on the display; and
a fourth type of polarity distribution pattern interval, wherein the provided display data have the fourth type of polarity distribution pattern on the display.

10. The multiple driving method according to claim 9, wherein one of the first type to the fourth type of polarity distribution pattern interval comprises 2+N frame cycles, the other one comprises 1+M frame cycles, the further other one comprises 2+N′ frame cycles, and the yet other one comprises 1+M′ frame cycles with N, N′, M and M′ being equal to −1, −1, 0 and 0 respectively.

11. The multiple driving method according to claim 9, wherein one of the first type to the fourth type of polarity distribution pattern intervals comprise 2+N frame cycles, the other comprises 1+M frame cycles, the further other comprises 2+N′ frame cycles, and the further other comprises 1+M′ frame cycles with N and M being integers satisfying one of the condition that N+M is equal to 0 and the other condition that N+M is equal to any positive even number, and N′ and M′ being integers satisfying one of the condition that N+M is equal to 0 and the other condition that N′+M′ is equal to any positive even number.

12. The multiple polarity inversion driving method according to claim 9, wherein one of the third type and the fourth type of polarity distribution patterns is in accordance with one of column inversion and frame inversion, the other is in accordance with one of row inversion, dot inversion, multi-dot inversion and multi+multi-dot inversion.

13. The multiple polarity inversion driving method according to claim 9, wherein one of the third type and the fourth type of polarity distribution pattern is n-dot inversion, the other is in accordance with one of row inversion, dot inversion, column inversion, frame inversion, n′ dot inversion and m+n″-dot inversion with n, n′, m and n″ being natural numbers larger than 1.

14. The multiple polarity inversion driving method according to claim 9, wherein one of the third type and the fourth type of polarity distribution patterns is in accordance with m+n-dot inversion, the other is in accordance with one of row inversion, dot inversion, column inversion, frame inversion, n′ dot inversion and m′+n″ dot inversion with m, n, n′, m′ and n″ being natural numbers larger than 1.

15. The multiple polarity inversion driving method according to claim 1, further comprising:
further providing subsequent display data in accordance with the other one or more inversion switching time units as repeated time unit respectively after providing the display data in accordance with the inversion switching time unit as the time unit.

16. A display driver, comprising:
a timing controller used for instructing an inversion switching time unit, wherein the inversion switching time unit has a number of different types of polarity distribution pattern intervals; and
a data driver used for providing display data to a display in accordance with an inversion switching time unit as a repeated time unit,
wherein the display data provided to the different types of polarity distribution pattern intervals by the data driver respectively have different types of polarity distribution patterns on the display.

17. The display driver according to claim 16, wherein in the polarity inversion switching time, the total number of times of switching each pixel of the display from positive polarity to negative polarity is substantially equal to the total number of times of switching each pixel of the display from negative polarity to positive polarity.

18. The display driver according to claim 16, wherein at least one of the different types of polarity distribution patterns is selected one of row inversion, column inversion, single dot inversion, multi-dot inversion, multi+multi-dot inversion, and frame inversion.

19. The display driver according to claim 16, wherein in the inversion switching time unit, the different types of polarity distribution pattern intervals comprise:
a first type of polarity distribution pattern interval, wherein the provided display data have the first type of polarity distribution pattern on the display; and
a second type of polarity distribution pattern interval, wherein the provided display data have the second type of polarity distribution pattern on the display.

20. The display driver according to claim 19, wherein one of the first type and the second type of polarity distribution pattern intervals comprises 2+N frame cycles, and the other comprises 1+M frame cycles with N and M being integers satisfying one of the condition that N+M is equal to 0 and the other condition that N+M is equal to any positive even number.

21. The display driver according to claim 19, wherein one of the first type and the second type of polarity distribution pattern is in accordance with one of row inversion and dot inversion, and the other is in accordance with one of column inversion and frame inversion.

22. The display driver according to claim 19, wherein one of the first type and the second type of polarity distribution pattern is in accordance with n-dot inversion, and the other of the first type and the second type of polarity distribution pattern is in accordance with one of row inversion, dot inversion, column inversion, frame inversion, n′ dot inversion and m+n″-dot inversion with n, n′, m and n″ being natural numbers larger than 1.

23. The display driver according to claim 19, wherein one of the first type and the second type of polarity distribution pattern is m+n-dot inversion, the other of the first type and the second type of polarity distribution pattern is in accordance with one of row inversion, dot inversion, column inversion, frame inversion, n′ dot inversion and m′+n″ dot inversion with m, n, n′, m′ and n″ being natural numbers larger than 1.

24. The display driver according to claim 19, wherein the inversion switching time unit, the different types of polarity distribution pattern intervals further comprise:
a third type of polarity distribution pattern interval, wherein the provided display data have the third type of polarity distribution pattern on the display; and
a fourth type of polarity distribution pattern interval, wherein the provided display data have the fourth type of polarity distribution pattern on the display.

25. The display driver according to claim 24, wherein one of the first type to the fourth type of polarity distribution pattern intervals comprise 2+N frame cycles, the other one comprises 1+M frame cycles, the further other one comprises 2+N′ frame cycles, and the yet other one comprises 1+M′ frame cycles with N, N′, M and M′ being equal to −1, −1, 0 and 0 respectively.

26. The display driver according to claim 24, wherein one of the first type to the fourth type of polarity distribution pattern interval comprises 2+N frame cycles, the other comprises 1+M frame cycles, the further other comprises 2+N′ frame cycles, and the further other comprises 1+M′ frame cycles with N and M being integers satisfying one of the condition that N+M is equal to 0 and the other condition that N+M is equal to any positive even number, and N′ and M′ being integers satisfying one of the condition that N+M is equal to 0 and the other condition that N′+M′ is equal to any positive even number.

27. The display driver according to claim 24, wherein one of the third type and the fourth type of polarity distribution pattern is in accordance with one of column inversion and frame inversion, the other is in accordance with one of row inversion, dot inversion, multi-dot inversion and multi+multi-dot inversion.

28. The display driver according to claim 24, wherein one of the third type and the fourth type of polarity distribution pattern is in accordance with n-dot inversion, and the other is in accordance with one of row inversion, dot inversion, column inversion, frame inversion, n′ dot inversion and m+n″-dot inversion with n, n′, m and n″ being natural numbers larger than 1.

29. The polarity inversion driving method according to claim 24, wherein one of the third type and the fourth type of polarity distribution pattern is in accordance with m+n-dot inversion, and the other is in accordance with one of row inversion, dot inversion, column inversion, frame inversion, n′-dot inversion and m′+n″ dot inversion with m, n, n′, m′ and n″ being natural numbers larger than 1.

30. The display driver according to claim 16, wherein the data driver further provides subsequent display data in accordance with the other one or more inversion switching time units as repeated time unit respectively after providing the display data in accordance with the inversion switching time unit as the time unit.

31. A display device, comprising:
the display driver according to claim 16; and
a display used for displaying corresponding image frames according to the display data provided by the display driver.

32. A display device, comprising:
a display driver used for providing display data in accordance with an inversion switching time unit as a repeated time unit, wherein the inversion switching time unit has a number of different types of polarity distribution pattern intervals; and
a display used for displaying corresponding image frames according to the display data provided by the display driver,
wherein in the different types of polarity distribution pattern intervals, the display data respectively have different types of polarity distribution patterns on the display.

33. A timing controller, comprising:
a timing controller for instructing an inversion switching time unit, wherein the inversion switching time unit has a number of different types of polarity distribution pattern intervals for driving a data driver, so that the data driver provides display data to a display in accordance with an inversion switching time unit as a repeated time unit,
wherein the display data provided to the different types of polarity distribution pattern intervals by the data driver respectively have different types of polarity distribution patterns on the display.
